(19) United States
(12) Patent Application Publication
(10) Pub. No.: US 2016/0134910 A1
(43) Pub. Date: May 12, 2016

(54) Provider Equipment Generation Of Customer User Interface

(71) Applicant: CHARTER COMMUNICATIONS OPERATING, LLC, St. Louis, MO (US)

(72) Inventors: Cheryl Kartye Davis, Castle Rock, CO (US); Peter Owen Brown, Lakewood, CO (US); Karie Reiko Yoshioka, Denver, CO (US)

(73) Assignee: CHARTER COMMUNICATIONS OPERATING, LLC, St. Louis, MO (US)

(21) Appl. No.: 14/819,313

(22) Filed: Aug. 5, 2015

Related U.S. Application Data
(60) Provisional application No. 62/033,209, filed on Aug. 5, 2014.

(51) Int. Cl. H04N 21/2343; H04N 21/482; H04N 21/45; H04N 21/236; H04N 21/239; H04N 21/222; G06F 3/0482; H04N 21/235

(52) U.S. Cl. CPC H04N 21/234363; G06F 3/0482; H04N 21/4821; H04N 21/2353; H04N 21/23614; H04N 21/2393; H04N 21/23439; H04N 21/2221; H04N 21/4532

(57) ABSTRACT

Systems, methods, apparatus and other mechanisms of providing a user interface (UI) at a service provider node in the television distribution system by encoding UI imagery to provide an encoded video stream bearing the UI imagery and configured for rendering as a UI screen via a client device video decoder, the UI screen including programming information associated with each of a subset of broadcast channels during a plurality of time intervals, and scaled live video imagery associated with each of the subset of broadcast channels; and at the service provider node, scaling video streams associated with at least the subset of broadcast channels to provide respective scaled live video imagery for the UI screen.

### CROSS-REFERENCE TO RELATED APPLICATION

This application claims the benefit of provisional patent application Ser. No. 62/033,209 filed on Aug. 5, 2014, entitled SYSTEM AND METHOD OF CLOUD-BASED USER INTERFACE (Attorney Docket No. CHTR/2014-05L), which provisional patent application is incorporated herein by reference in its entirety.

### FIELD OF THE INVENTION

The invention relates to user interface delivery techniques and, more particularly but not exclusively, to providing user interface mechanisms to client devices within a television distribution system.

### BACKGROUND

Cable television service providers, satellite television service providers and other television or content distribution companies offer numerous broadcast channels as well as on-demand content to subscribers via set top boxes (STBs) and other customer premise equipment (CPE). A subscriber interacts with an Electronic Program Guide (EPG) or other User Interface (UI) provided via the STB to select broadcast channels, on-demand content and so on for viewing, performing various administrative functions and so on.

Over time the deployed CPE within the service provider network may comprise STBs of differing levels of capability, possibly from different manufacturers, such that a preferred look and feel of EPG and UI provided to subscribers via the deployed CPE may only be supported by a subset of the deployed CPE. In this case, it becomes difficult to maintain a consistent look, feel and function across the deployed CPE of the service provider.

### SUMMARY

Various deficiencies in the prior art are addressed by systems, methods, apparatus and other mechanisms of providing a user interface (UI) at a service provider node in the television distribution system by encoding UI imagery to provide an encoded video stream bearing the UI imagery and configured for rendering as a UI screen via a client device video decoder, the UI screen including programming information associated with each of a subset of broadcast channels during a plurality of time intervals, and scaled live video imagery associated with each of the subset of broadcast channels; and at the service provider node, scaling video streams associated with at least the subset of broadcast channels to provide respective scaled live video imagery for the UI screen.

The various embodiments provide Electronic Program Guide (EPG) or other User Interface (UI) functions of consistent look, feel and function via Customer Premise Equipment (CPE) of varying capabilities. In various embodiments imagery, information and functional elements associated with an EPG or UI are combined at a server or other network entity remote from a subscriber STB and provided to the subscriber STB via a compressed video stream configured to be processed by even the most rudimentary STB.

### BRIEF DESCRIPTION OF THE DRAWING

The teachings of the present invention can be readily understood by considering the following detailed description in conjunction with the accompanying drawing, in which:

FIG. 1 depicts a high-level block diagram of an interactive information distribution system;

FIG. 2 depicts a high-level block diagram of an exemplary subscriber terminal suitable for use in the interactive information distribution system of FIG. 1;

FIG. 3 graphically depicts a functionally bifurcated user interface structure according to one embodiment;

FIG. 4 depicts a flow diagram of a method suitable for use at a service provider;

FIG. 5 depicts a flow diagram of a method suitable for use at a UI renderer at a client device;

FIG. 6 depicts a flow diagram of a method suitable for use at messaging proxy at a client device;

FIG. 7 depicts a flow diagram of a method suitable for use at a provider element (PE) configured to provide UI functions to client devices;

FIG. 8 depicts a high-level block diagram of a computing device suitable for use in performing functions described herein; and

FIGS. 9-18 depict user interface screens in accordance with various embodiments.

To facilitate understanding, identical reference numerals have been used, where possible, to designate identical elements that are common to the figures.

### DESCRIPTION

The invention will be primarily described within the context of systems, methods, apparatus and other mechanisms for generating user interface (UI) assets, delivering the UI assets to a client device, and using the delivered UI assets at the client device to implement various UI functions to facilitate thereby various subscriber functions such as account management functions, content selection functions and the like.

The various embodiments provide user interfaces (UIs) served from remote elements in a network, such as a cable network head end or other service provider server (generically “the cloud”), which allow cable television operators and other network operators to deliver robust content, features and services quickly and easily to both next generation set-top boxes and existing set-top boxes so that users of both types of set-top boxes are provided with a consistent user experience. Thus, while the invention will be primarily described within the context of a heterogeneous interactive information distribution system, it should be noted that the invention may be advantageously adapted to any system including client devices such as information receivers, set top boxes (STBs), set top terminals (STTs) and the like requiring a user interface (UI) function such as a digital television electronic programming guide (EPG), video on demand (VOD) client, digital video recorder (DVR) and the like.

Generally speaking, various embodiments provide UI functionality at a client device via a messaging proxy adapted to cooperate with a video decoder/renderer. The video decoder/renderer operates to decode a compressed video stream bearing UI imagery to provide corresponding decoded video streams or signals suitable for use by a presentation device. The messaging proxy is adapted to process tuner commands, DVR commands and/or other commands in response to user interaction with presented UI imagery such that local functions may be implemented without server interaction.

Various embodiments may be implemented within the context of a standard definition STB, high definition STB, DVR, a set-top terminal with or without a broadband connection, a messaging proxy from MPEG UI to operating system (OS), an OS abstraction mechanism, one or more dedicated sockets for external systems, a state or usage reporting mechanism, a cache, programmatic merging of Quadrature Amplitude Modulated (QAM) video and MPEG UI or other UIs, and so on.

While generally described with respect to MPEG video encoding and packet transport formats, it will be appreciated by those skilled in the art that other video encoding and/or transport formats may be utilized within the context of the various embodiments.

Any of the various embodiments discussed herein may be implemented within the context of an information distribution system such as a telecommunications, cable television, satellite or other network adapted according to the embodiments, a system according to any of the embodiments, hardware and/or software according to any of the embodiments, a set-top box and related server/transport entities according to any of the embodiments and so on.

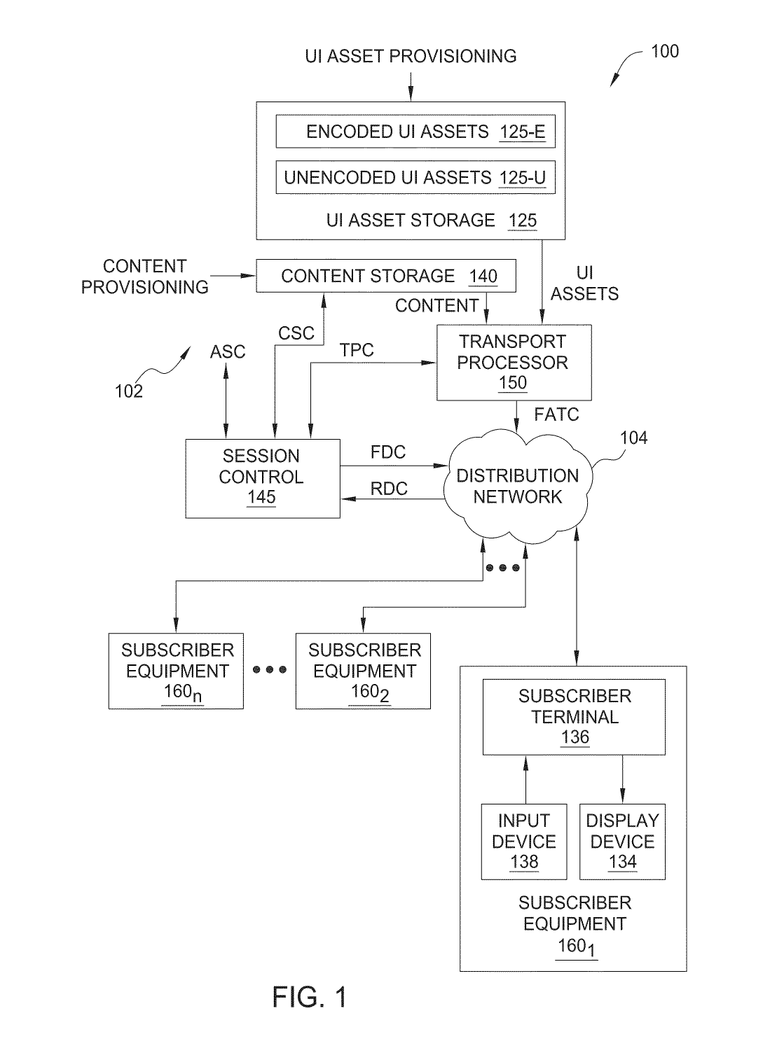

FIG. 1 depicts a high-level block diagram of an interactive information distribution system. Specifically, FIG. 1 depicts a high-level block diagram of an interactive information distribution system 100 capable of supporting various embodiments of the present invention. The system 100 contains service provider equipment 102, a distribution network 104 and subscriber equipment 106.

The system 100 of FIG. 1 is depicted as a heterogeneous system in that subscriber equipment 106 may comprise subscriber terminals, also known as set-top terminals (STTs) or set-top boxes (STBs), of differing capability with respect to control processing, bandwidth and/or graphics processing; generally speaking, differing capabilities in terms of processing resources and memory resources. However, subscriber equipment 106 capable of implementing the various embodiments described herein includes a basic or minimal level of functionality, such as an ability to decode an MPEG-2 transport stream including video information (and associated audio information) and process the decoded video (and associated audio information) to produce video (and audio) streams or signals suitable for use by a presentation device.

The distribution network 104 may comprise one or more of a Hybrid Fiber Coax (HFC) for cable, optical network, IP network, Plain Old Telephone System (POTS) or digital subscriber line (DSL), terrestrial broadcast system like Multichannel Multipoint Distribution Service (MMDS) or Local Multipoint Distribution Service (LMDS), or satellite distribution system like Direct broadcast satellite (DBS).

The service provider equipment 102 comprises, illustratively, a client device having computing and processing modules for implementing various functions, such as a user interface (UI) asset storage module 125, a content storage module 140, a session controller 145 and a transport processor 150.

The UI asset storage module 125 is used to store UI assets such as encoded UI assets 125-E or unencoded UI assets 125-U. The encoded UI assets 125-E may comprise still or moving UI imagery (e.g., UI screens) encoded according to MPEG or other video encoding formats. The UI assets may be stored in several forms, such as unencoded, encoded but not transport packetized, encoded and transport packetized and the like. In various embodiments, the UI assets are stored as transport packets according to a specific protocol, such as MPEG-2 transport packets. In this manner transport encoded UI asset packets may be easily multiplexed into a transport stream being formed.

The content storage module 140 is used to store content such as movies, television programs and other information offerings. The content may be stored in several forms, such as unencoded, encoded but not transport packetized, encoded and transport packetized and the like. In various embodiments, the content is stored as transport packets according to a specific protocol, such as MPEG-2 transport packets. In this manner transport encoded content may be easily multiplexed into a transport stream being formed.

The transport processor 150 combines or multiplexes content and/or UI asset data as needed to provide an output data stream for transmission to a subscriber via a forward application transport channel (FATC) within the distribution network 104. In various embodiments, the transport processor 150 performs transport packetizing functions for content and/or UI asset data as needed in conformance with the FATC transport protocols. In various embodiments, the transport processor 150 also performs video encoding functions such as MPEG encoding of unencoded UI assets.

The session controller 145 (or session manager) provides session control of the information flowing to and from the UI asset storage module 125 and content storage module 140. The session controller 145 provider controls communications between the server equipment 102 and subscriber equipment 106, such as between a cable system head-end and one or more set-top terminals. The session controller 145 produces an asset storage control signal ASC for controlling and communicating with the UI asset storage module 125, a content storage control signal CSC for controlling and communicating with the content storage module 140, and a transport processor control signal TPC for controlling and communicating with the transport processor 150.

The session controller 145 sends data, such as commands, encryption keys and the like to subscriber equipment 106 via a forward data channel (FDC). The session controller 145 receives subscriber equipment data, such as information stream requests, session initiation data (set-top identification, capability, and the like), user clickstream information and/or other data from subscriber equipment 106 via a reverse data channel (RDC).

The FDC and RDC are supported by the distribution network 104 and may comprise relatively low bandwidth data channels, such as 1-2 megabits per second data channels utilizing QPSK, QAM or other modulation techniques. The FDC and RDC are also known as “out of band” channels, while a relatively high bandwidth forward application transport channel (FATC) is also known as an “in-band” channel. In various embodiments, the session controller 145 contains interface devices for sending control information via the forward data channel FDC and receiving control information via the reverse data channel RDC using so-called “out of band” carrier frequencies.

The distribution network 104 can be any one of a number of conventional broadband communications networks that are available such as a fiber optic network, a telecommunications network, a cable television network and the like. In various embodiments, distinct FATC, FDC and RDC channels are not used. For example, in various embodiments the distribution network 104 may comprise an IP network that may include more than one access network, may traverse core Internet networks, may traverse third-party networks and so on.

The transport processor 150 provides various forward content channel transmission interface functions of the system 100 of FIG. 1. Specifically, the transport processor 150 is coupled to subscriber equipment via the forward applications transport channel (FATC). In various embodiments, the forward application transport channel (FATC) is supported by the distribution network 104 and comprises a relatively high bandwidth communications channel well suited to carrying video, audio and data such as, for example, multiplexed MPEG-2 transport packets. It should be noted that data normally conveyed to a set-top box via the FDC may be included in the FATC data stream.

The transport processor 150 contains a multiplexer or combiner for multiplexing or combining the content information stream CONTENT provided by content storage module 140 and the asset information stream ASSETS provided by asset storage module 125.

The subscriber equipment 106 comprises, illustratively, a subscriber terminal 136, display device 134 and input device 138. The subscriber terminal 136 may comprise a set-top terminal, set-top box, communications terminal, computer, hand-held tablet or other computing device, smartphone and/or other device capable of interacting with the service provider equipment 102 via the distribution network 104. The display device 134 may comprise any display device, such as a conventional television, computer monitor, the computer display, a smart phone display and so on. The input device 138 may comprise any input device, such as a remote control, a keyboard, a touch screen device and so on. Generally speaking, the subscriber terminal 136 receives from the input device 138 data indicative of user interaction with the input device 138. Generally speaking, the subscriber terminal 136 provides presentation signals of still or moving imagery suitable for presentation via the display device 134.

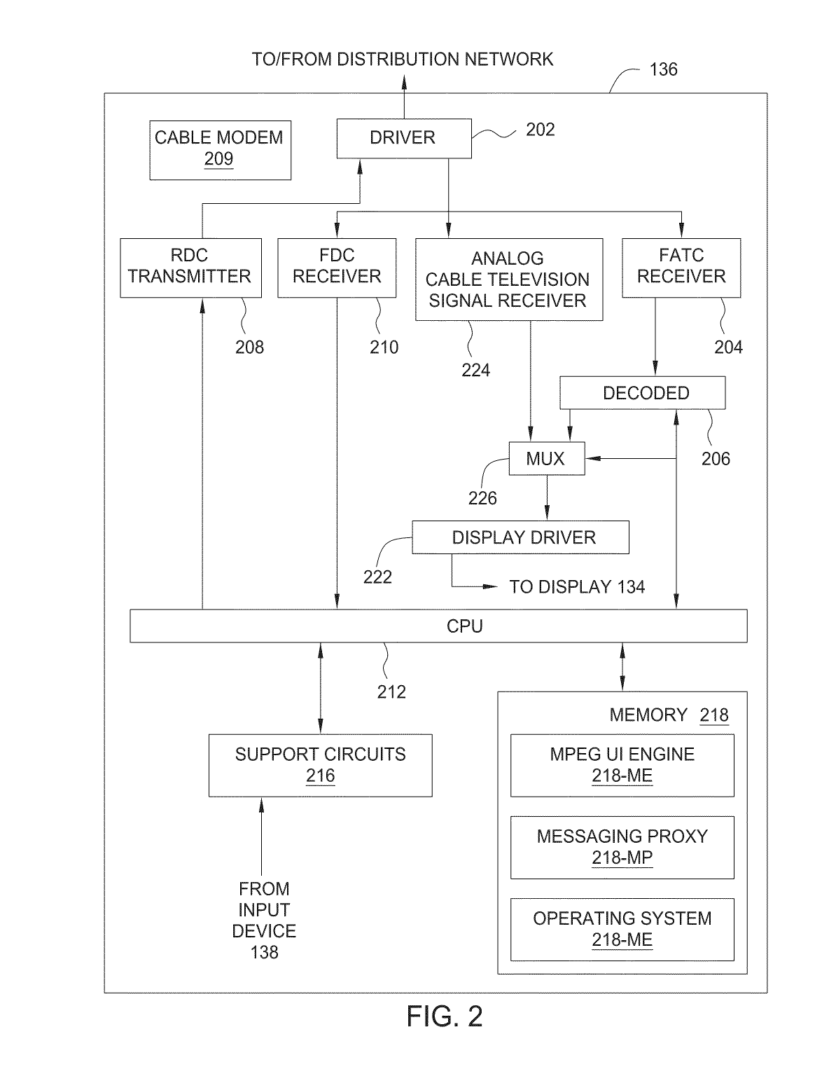

FIG. 2 depicts a high-level block diagram of an exemplary subscriber terminal suitable for use in the interactive information distribution system of FIG. 1. Specifically, FIG. 2 depicts a high level block diagram of a subscriber terminal 136 comprising a diplexer 202, a back channel (RDC) transmitter 208, an information channel (FATC) receiver 204, a command channel (FDC) receiver 210, an information decoder (e.g., MPEG decoder) 206, a conventional television signal receiver 224, a multiplexer 226, a display driver 222, various support circuits 216, a processor 212 and memory 218. In various embodiments, the subscriber terminal includes a cable modem 209 operative to communicate with a broadband connection (not shown) to thereby implement various functions associated with the RDC, FDC and/or FATC.

The diplexer 202 couples the (illustratively) three channels of the distribution network carried by a single cable to the transmitter 208 and receivers 204 and 210.

Each receiver 204 and 210 contains any necessary tuners, amplifiers, filters, demodulators, depacketizers, decoders and so on, to tune, downconvert, and depacketize and otherwise retrieve the signals from the distribution network. The information channel receiver 204 may contain a conventional “in-band” QAM demodulator or other appropriate high-bandwidth demodulator. Control channel receiver 210 may comprise an “out-of-band” QPSK demodulator for handling command channel data carried by the forward data channel.

The decoder 206 processes data packets carrying information provided by the QAM demodulator to provide useable signals for the display device 134 or other presentation device or recording device. The decoder 206 operates to decode audiovisual streams such as compressed elementary video streams, MPEG video streams, MPEG-2 transport streams and so on as appropriate. The decoder 206 is in communication with and controlled by the controller 212.

The conventional cable television signal receiver 224 contains a tuner and conventional analog television demodulator, illustratively an ATSC, DVB, NTSC, PAL or SECAM demodulator.

The multiplexer 226 selectively couples the demodulated analog television signal from the television signal receiver 224 or the decoded video signal from the decoder 206 to the display drive 222, which conventionally processes the selected signal to produce a presentation or video signal suitable for use by, illustratively, the display device 134. The multiplexer 226 is in communication with and controlled by the controller 212.

Thus, each subscriber terminal 136 receives data streams from the FATC or FDC, demodulates the received data streams and, in the case of video streams, decodes or otherwise processes the demodulated video streams to provide video presentation streams suitable for use by display device 134. In addition, the subscriber terminal 136 accepts commands from the remote control input device 138 or other input device. These commands are formatted, modulated, and transmitted through the distribution network 104 to the session controller 145. This transmission may be propagated via the RDC, though any communication channel capable of propagating data to the service provider equipment 102 may be used. Subscriber terminal 136 for different subscriber equipment 106 may vary in the format of encoding and/or transport protocol supporting, such as supporting one or more of MPEG-2, MPEG-4, DVB and/or other encoding or transport protocols.

Within the set-top terminal 136, the controller 212 is supported by memory 218 and various support circuits 216 such as clocks, a power supply, an infrared receiver and the like. The memory 218 is depicted as including various program modules, including MPEG UI engine 218-ME, a messaging proxy 218-MP and an operating system 218-OS. The operation of these various program modules will now be described with respect to an MPEG UI generation function.

### Thin Message Marshaling Proxy

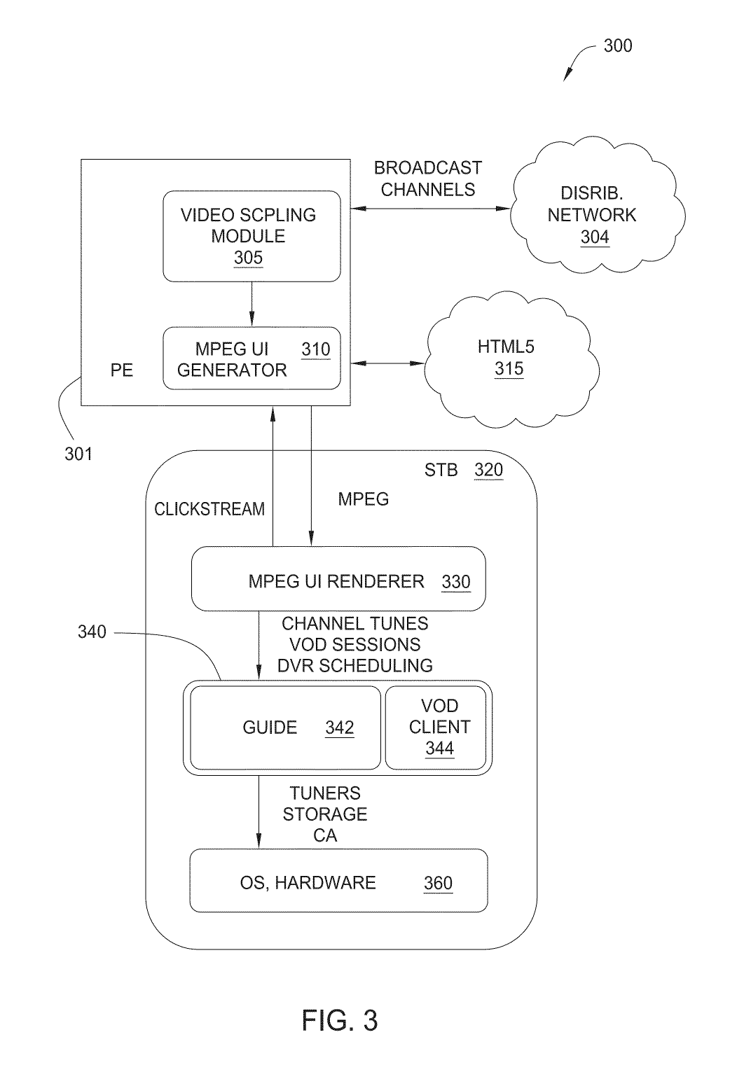

FIG. 3 graphically depicts a functionally bifurcated user interface structure according to one embodiment. Specifically, FIG. 3 depicts a UI in which a server provides UI imagery to the client via encoded video streams, receives clickstream data associated with user interaction at the client and adapts the served UI imagery and provides server-side services to the client in response to the clickstream data. A client-side messaging proxy identifies and acts upon clickstream data associated with local client functions via APIs that hook into the local OS of the client, illustratively a STB.

FIG. 3 depicts an MPEG user interface (UI) generator 310 in communication with a network 315 and a set-top box (STB) 320.

The MPEG UI generator 310 may be located or operational at a service provider access node 301 associated with the STB 320, some other access node, a node within the network 315, a remote server, a UI vendor system, a cable television network head end and the like. For example, in various embodiments, the MPEG UI generator 310 is implemented at the session controller 145 or other elements within the service provider equipment 102 discussed above with respect to the system 100 of FIG. 1.

The STB 320 may comprise an STB or other device or module capable of decoding/processing MPEG transport streams and the like, perhaps an STB having a relatively limited graphical user interface (GUI) capability. For example, in various embodiments, the STB 320 comprises a subscriber terminal 136 such as discussed above with respect to the subscriber equipment 106 of the system 100 of FIG. 1.

It should be noted that the various embodiments described herein are generally described within the context of the various MPEG-related or MPEG-like audiovisual compression and/or transport processing standards and protocols. However, various embodiments are adapted to use other audiovisual compression and/or transport processing standards and protocols, such as those associated with the Digital Video Broadcasting (DVB), Integrated Services Digital Broadcasting (ISDB), Advanced Television Systems Committee (ATSC) and so on.

Generally speaking, the UI generator 310 receives click stream and/or other information from the STB 320 indicative of user interaction with the user interface. In response to the click stream information, the UI generator 310 communicates with various network elements (not shown in FIG. 3) within the network 315 (illustratively, an HTML 5 compliant network) to retrieve appropriate imagery therefrom, which imagery is then adapted by the UI generator 310 for subsequent use by the STB 320. In particular, the MPEG UI generator 310 converts still or moving imagery received from the network 320 into MPEG-compliant imagery for propagation toward a STB.

MPEG-encoded or compliant UI imagery provided by the MPEG UI generator 310 (as well as other data streams) is processed by a MPEG UI renderer 330 at the STB 320 to provide thereby streaming video, audio, data and the like for presentation. In various embodiments, channel tuning data, video on demand (VOD) session data, digital video recorder (DVR) scheduling data and the like may be communicated between the STB 320 and UI generator 310 via the click stream (upstream) path, MPEG transport channel (downstream) path or other paths. For example, in various embodiments the STB may include a Data Over Cable Service Interface Specification (DOCSIS) or other modem capability (not shown) adapted for communicating data to/from the STB.

In various embodiments, the UI renderer is implemented using MPEG demux/decode capabilities resident or otherwise implemented at the STB 320. In various embodiments, the UI renderer is implemented using MPEG demux/decode capabilities outside of the STB 320.

Data extracted by the UI renderer 330 is further processed by one or both of a guide program 343 and VOD client 344. These entities provide resulting tuner, storage and other information to the underlying operating system (OS) and hardware 360 of the STB 320.

Generally speaking, embodiments described herein with respect to FIG. 3 may be conceptualized as a “guide without a guide” in that the entirety of the user interface is rendered via MPEG (more generally, compressed video including still or moving UI imagery). In this manner, the bloat and complexity of the traditional user interface is removed from the set-top box and replaced with a thin layer with the sole purpose of acting as a proxy between MPEG user interfaces and the underlying OS for relaying tuner and DVR commands.

In various embodiments, a video scaling module 305 cooperates with the MPEG UI generator 310 to provide thereto scaled or thumbnail video imagery associated with various broadcast channel video streams received via, illustratively, a distribution network 304 or other network. The video scaling module 305 operates to spatially scale broadcast channel video of a first frame size to produce corresponding scaled or thumbnail video of a second frame size, where the second frame size is smaller than the first frame size. For example, in various embodiments the broadcast channel video streams having the first frame size may conform to a 4K, HDTV, SDTV or other video stream format having one or more defined frame sizes, while the second frame size may comprise a specific pixel height and pixel width adapted for insertion into the UI imagery, such as part of a video bar, adjacent and similar in size to a programming grid element, or other location in a UI screen. Frame size may be reduced by removing an appropriate number of rows or columns of pixels. Frame size may be reduce as a percentage of initial frame size (e.g., half, quarter, etc.) or as needed to provide a common frame size of, illustratively, 100×100 pixels or some other N×M pixel size.

Optionally, the video scaling module 305 operates to temporally scale received broadcast channel video of a first frame rate to produce corresponding scaled or thumbnail video of a second frame rate, where the second frame rate is smaller than the first frame rate. For example, in various embodiments the received broadcast channel video may conform to a frame rate of 30 frames per second, 60 frames per second or some other frame rate, while the second frame rate may comprise some percentage of the initial frame rate (e.g., half, quarter, etc.), or a predetermined common frame rate of, illustratively, five, 10, 15 or some other number of frames per second.

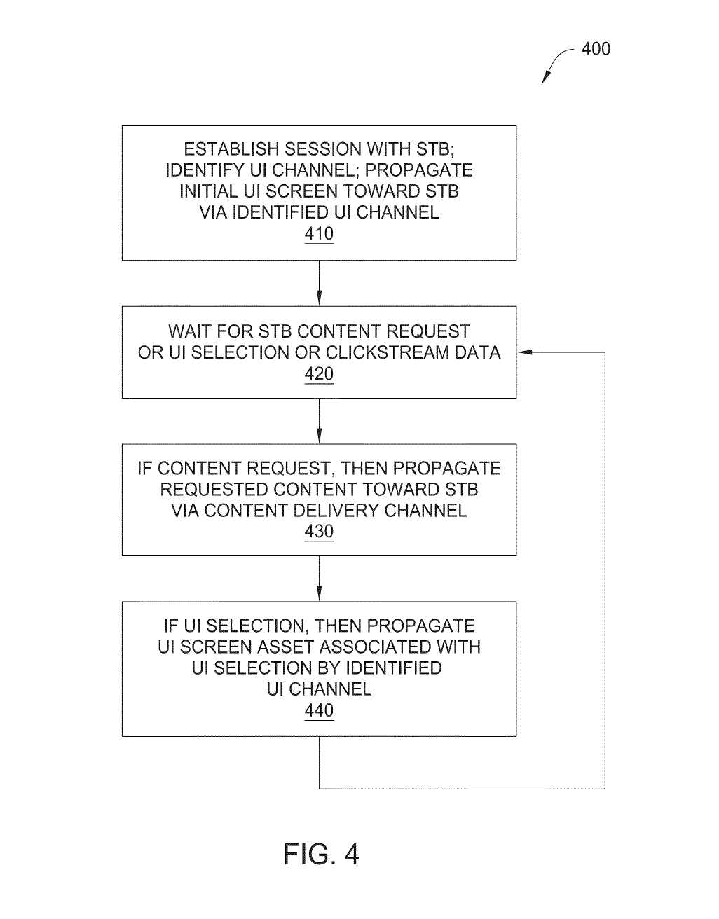

FIG. 4 depicts a flow diagram of a method suitable for use at a service provider. Specifically, FIG. 4 depicts a flow diagram of a method suitable for use at an MPEG UI generator, such as described herein with respect to the various figures. For example, the method 400 of FIG. 4 may be implemented at, illustratively, the session controller 145 of FIG. 1, the MPEG UI generator 310 of FIG. 3 and so on. The method 400 is adapted for providing UI screens via one or more selected video channels, such as video channels propagated toward a STB.

At step 410, the MPEG UI generator establishes a session with an STB, identifies a specific channel within a plurality of video channels provided to the STB as a UI channel, and propagates one or more initial UI screen assets towards the STB via the identified UI channel. The UI screen assets are adapted to be decoded at the STB to produce a video presentation stream suitable for use by, illustratively, a display device. Various embodiments of UI screen assets will be discussed in more detail below with respect to the various figures.

At step 420, the MPEG UI generator waits to receive an STB content request or UI selection or clickstream data generated by, illustratively, a STB of other client device. In various embodiments, clickstream data associated with a local client function will have been processed by a messaging proxy or other entity at the client. In these embodiments, the local client function clickstream data may be ignored from a functional perspective, though the data may be useful for subscriber management, demographic profiling, usage statistics and the like. In various embodiments, clickstream data associated with a local client function may have been omitted from the clickstream data provided by the client device. In various embodiments, a flag or indicator is associated with local client function of extreme data such that it can be readily identified as such.

At step 430, if an STB content request is received by the MPEG UI generator, then the requested content is propagated toward the STB via a content delivery channel. For example, if the method 400 is implemented using session manager 145, then the session manager 145 causes the content storage module 142 to begin streaming the requested content to the STB via the transport processor 150 and distribution network 104. If the method 400 is implemented using an access node or other network element, then the access node or other network element forwards the content request to an appropriate content request fulfillment element, such as a session manager, content server and the like.

At step 440, if data indicative of a UI selection is received by the MPEG UI generator, then the UI screen assets associated with the UI selection data are propagated toward the STB via the identified UI channel. For example, if the method 400 is implemented using session manager 145, then the session manager 145 causes the UI asset storage module 125 to stream the appropriate UI screen asset (or assets) to the STB via the transport processor 150 and distribution network 104.

The method 400 then waits for a next content request or UI selection. At any time, the MPEG UI generator, session manager or other entity may change the identified UI channel. In this case, at least that portion of step 410 associated with identifying the UI channel to the STB is repeated.

The method 400 generally provides for an MPEG UI generator in which initial and subsequent UI assets are streamed to an STB via a designated UI channel in response to data indicative of a user interaction or selection of the UI screen represented by the initial or subsequent UI assets.

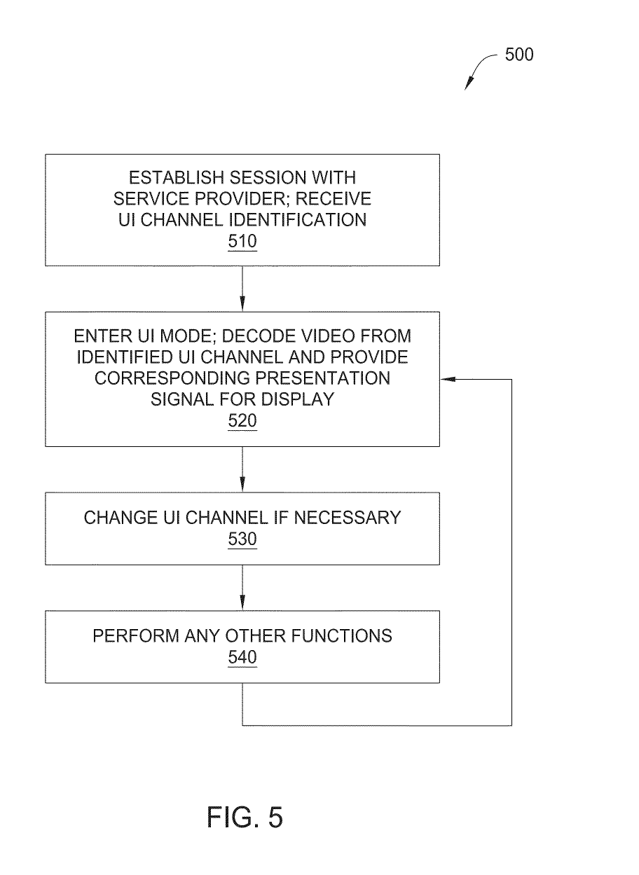

FIG. 5 depicts a flow diagram of a method suitable for use at a UI renderer at a client device. Specifically, FIG. 5 depicts a flow diagram of a method suitable for use at an MPEG UI renderer, such as described herein with respect to the various figures. For example, the method 500 of FIG. 5 may be implemented at, illustratively, the subscriber terminal 136 of FIG. 1, the MPEG UI renderer 330 of FIG. 3 and so on. The method 500 is adapted for decoding received UI assets to produce a video presentation stream suitable for use by, illustratively, a display device.

At step 510, the MPEG UI renderer establishes a session with the service provider and receives channel identification information associated with a channel to be used as a UI channel.

At step 520, the MPEG UI renderer enters a UI mode in which UI assets and the like received via the identified UI channel are decoded to produce a video presentation stream for subsequent display. For example, initial UI screen assets transmitted at step 410 of the method 400 are received at step 520 of the method 500, where the received assets are decoded and used to provide initial UI imagery on a display device for viewing by a user.

At step 530, the UI channel is changed if necessary, such as in response to a command received from the MPEG UI generator, session manager 145 or other network entity.

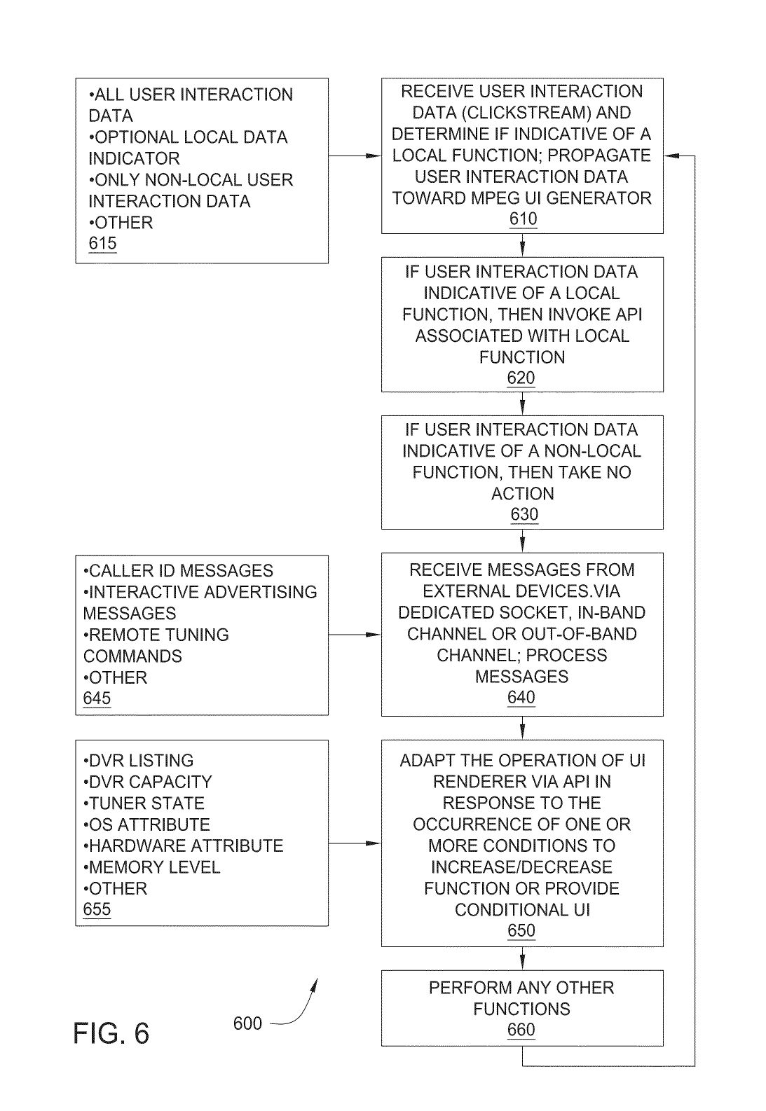

At step 540, any other functions to be performed by the UI renderer are performed, such as those noted below with respect to FIG. 6. For example, in various embodiments, the conditional UI rendering is provided wherein the UI renderer is responsive to the messaging proxy, and the messaging proxy causes various modifications to UI rendering operations in response to certain conditions (e.g., client device memory or processor resource conditions, subscriber level, subscriber authorization termination and so on). The method 500 may be continually repeated.

In various embodiments, a locally rendered mini-guide is invoked by the UI renderer at the client device if one or more of steps 520-540 fail. For example, if the session initiation does not result in receiving UI channel identification, or if the amount of time to receive UI channel identification exceeds a predetermined amount (e.g., two seconds, 10 seconds and the like), or if the video from the identified UI channel is corrupted or otherwise unable to be decoded. In these and other cases where the cloud-based UI is unavailable for whatever reason, the locally rendered mini-guide is invoked to provide at least some UI functionality to the user. The mini-guide may comprise a simple grid populated with a minimum amount of program guide data. The mini-guide may be generated using video presentation capabilities and/or graphics presentation capabilities at the client device.

FIG. 6 depicts a flow diagram of a method suitable for use at a messaging proxy at a client device. Specifically, FIG. 6 depicts a flow diagram of a method suitable for use at a messaging proxy such as described herein with respect to the various figures. For example, the method 600 of FIG. 6 may be implemented at, illustratively, the subscriber terminal 136 of FIG. 1, the messaging proxy 340 of FIG. 3 and so on. The method 600 is adapted for propagating clickstream data toward the MPEG UI generator, invoking local APIs into the STB OS to invoke local functions selected by a user interacting with the STB, and performing other functions as needed according to the various embodiments.

At step 610, the messaging proxy receives user interaction data (i.e., clickstream data) and determines if the received data is indicative of a local function, such as a channel tuning function, a local VOD session function, a local DVR scheduling function and the like. In addition, the clickstream data is propagated toward the MPEG UI generator, session manager or other service provider equipment entity. Referring to box 615, all of the user interaction data may be propagated (with or without an optional local data indicator included within the propagating clickstream), only non-local user interaction data may be propagated or some combination thereof. In various embodiments, status information, performance information, error codes and the like are also propagated.

At step 620, if the user interaction data is indicative of a local function, then the application programming interface (API) associated with the local function is invoked. For example, in the case of data indicative of a local channel tuning function, the API associated with channel tuning is invoked to responsibly select the appropriate video channel (and corresponding audio channel).

At step 630, if the user interaction data is indicative of a non-local function, then no action is taken. For example, in the case of data indicative of UI manipulation requiring display of a different UI screen (e.g., a different block of channels, a different block of time etc.), there is no local action to be taken since the MPEG UI generator must perform this task. It is noted that in the method 400 discussed above with respect to FIG. 4, only STB content requests or UI selections are processed. Thus, clickstream data received by the MPEG UI generator indicative of a local STB function will be ignored as appropriate.

At step 640, in various embodiments the messaging proxy receives messages from external devices via a dedicated socket, an in-band channel and/or an out-of-band channel. These messages are then processed by the messaging proxy as appropriate. Referring to box 645, received messages may comprise caller ID messages, interactive advertising messages, remote tuning commands and/or other messages. In various embodiments the external device sending these messages comprises a mobile device such as a smart phone, tablet, laptop or other device. In various embodiments, other client devices within the same house or associate of the same subscriber may communicate such messages to the client device.

At step 650, in various embodiments the messaging proxy adapts the operation of the UI renderer via an API in response to the occurrence of one or more conditions to thereby increase or decrease UI function, provide a conditional UI, improve UI robustness and the like. Referring to box 655, such conditions may comprise or be related to the DVR listing, DVR capacity, tuner state, OS attribute, order attribute, memory level and/or other conditions.

At step 660, any other functions to be performed by the messaging proxy are performed. For example, in various embodiments the messaging proxy is adapted to fetch encoded UI video assets or portions thereof via a broadband connection associated with said client device. That is, in embodiments including a cable modem, fiber interface or other broadband access device, the messaging proxy may request the delivery of encoded UI video assets or portions thereof, as well as advertising content or other content via a broadband connection to improve overall performance of the user interface, client device and system in general. The method 600 may be continually repeated.

In various embodiments, additional capabilities are included to reduce the complexity of a set-top box needed to support the various UI features discussed herein in the following example.

In various embodiments, a thin message marshaling proxy does not include actual user interface; rather, it is instantiated at the same software layer as a traditional or underlying “guide” and is optionally provided with application programming interfaces (APIs) that extend abstractions of the hardware and OS up to the MPEG rendering component. These embodiments may include implementations within the context of DVR listings, DVR capacity, tuner state, OS/Hardware attributes, available memory and the like. These can be cleanly exposed to the MPEG UI renderer such that more robust and/or conditionally rendered user interfaces will be possible.

In various embodiments, in addition to serving as a proxy to the OS, the thin message marshaling proxy layer is implemented as one or more dedicated sockets to eliminate the need for such additional clients. It is noted that many traditional guides do not have innate or well-defined external messaging capabilities. Thus, activities such as pushing caller ID messages, interactive ads, remote tune commands from a Smartphone and so on which typically require other dedicated application environments (Enhanced TV Binary Interchange Format, etc.) may be addressed as well.

It is noted that traditional program guides do not reliably report state or usage information. For example, some of these program guides collect or “batch up” DVR status information for periodic transmission to a remote server, while others rely on external monitoring applications to be built. Thus, in various embodiments, DVR status information and other status information is included within the new layer discussed herein, thereby eliminating a need for additional components and allowing operators to reliably develop cloud services. This would include harvesting DVR status or tuning activity in real time—allowing for cloud based access to DVR information from other devices, understanding of real time usage behaviors and so on.

It is noted that since a thin client has no UI of its own, it would have significantly more memory at its disposal than a traditional monolith guide. Therefore, in various embodiments, available memory is adapted to cache portions of the MPEG UI.

Within the context of mid range set-top boxes with embedded broadband connections (e.g. cable modems), a thin client according to the various embodiments is adapted to fetch the MPEG UI, portions of it or various changes via the broadband connection. In this manner, upstream contention on a cable plant may be significantly reduced.

In various embodiments, the client is adapted to reduce a bitrate of a unicast signal by programmatically merging quadrature amplitude modulated (QAM) video and the UI imagery.

In various embodiments, the client is adapted to utilize specific sockets or interfaces exposed for the purpose of providing remote diagnostics of the OS/hardware/UI of the STB.

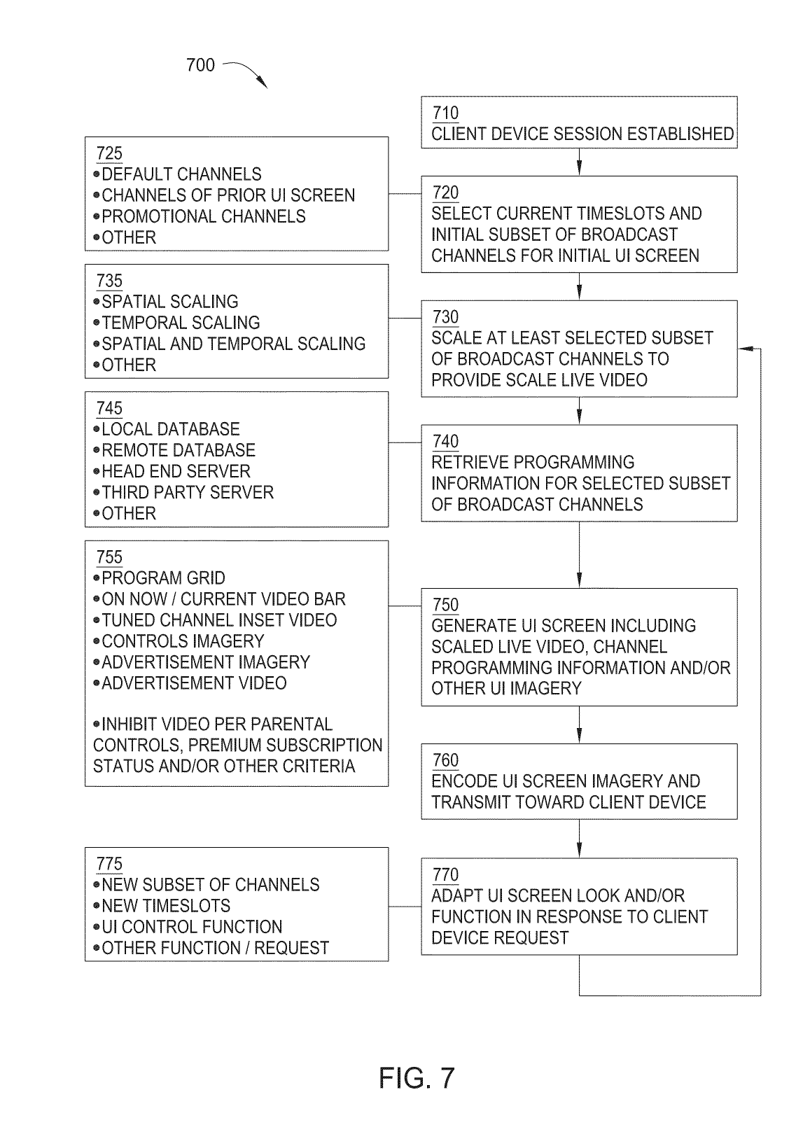

FIG. 7 depicts a flow diagram of a method suitable for use at a provider element (PE) configured to provide UI functions to client devices. The PE may comprise a service provider access node associated with the client device, some other access node, a node within the network 315 or 304, a remote server, a UI vendor system, a cable television network head end and the like. For example, in various embodiments, the MPEG UI generator 310 is implemented at the session controller 145 or other elements within the service provider equipment 102 discussed above with respect to the system 100 of FIG. 1. The method 700 is adapted for providing UI screens via one or more selected video channels, such as video channels propagated toward a STB.

At step 710 a client device session is established, during which a specific channel within a plurality of video channels provided to the client device is identified as a UI transmission channel or path.

At step 720, information pertaining to an initial UI screen is selected; illustratively, current timeslots and an initial subset of broadcast channels. Referring to box 725, the initial subset may comprise default broadcast channels, broadcast channels associated with a prior UI screen (e.g., last screen viewed by client device user), one or more promotional channels or general selected according to other criteria.

At step 730, video associated with at least the selected subset of broadcast channels is scaled to provide corresponding scaled live video. In various embodiments, all or a large portion of the broadcast channels are scaled and real time so that UI screens may be quickly assembled and distributed to many client devices. Referring to box 735, video scaling of the broadcast channel video may comprise spatial scaling, temporal scaling, spatial and temporal scaling or some other form of scaling.

At step 740, programming information pertaining to content transported via the selected subset of broadcast channels is retrieved. Referring to box 745, the programming information may be retrieved from a local database, remote database, head end server, third-party server or some other source of programming information.

At step 750, the UI screen is generated and includes the scaled live video associated with the selected subset of broadcast channels, the corresponding channel programming information, as well as other UI imagery to be included in the UI screen. Referring to box 755, the UI screen may include a program grid, a “On Now” or “current time” video bar, in said video associated with a currently tuned channel, advertisement imagery, advertisement video and so on. In various embodiments, the inclusion of scaled live video is inhibited for premium channels not associated with the client device and/or broadcast channels or content blocked in accordance with parental controls.

At step 760, the UI screen is encoded and transmitted toward the client device via the UI transmission channel or path.

At step 770, the UI screen look and/or function is adapted in response to a request from the client device. Referring to box 775, such a request may comprise an indication of selecting a new subset of channels for program guide or grid viewing, a selection of new timeslots for program guide or grid viewing, a UI control function such as a filter function, favorites function, parental control/password function and so on. Other functions and/or requests may also be processed at this time in response to a client device request. The method 700 then proceeds to step 730 to incorporate a new subset of broadcast channels and/or new timeslots into a new UI screen is appropriate.

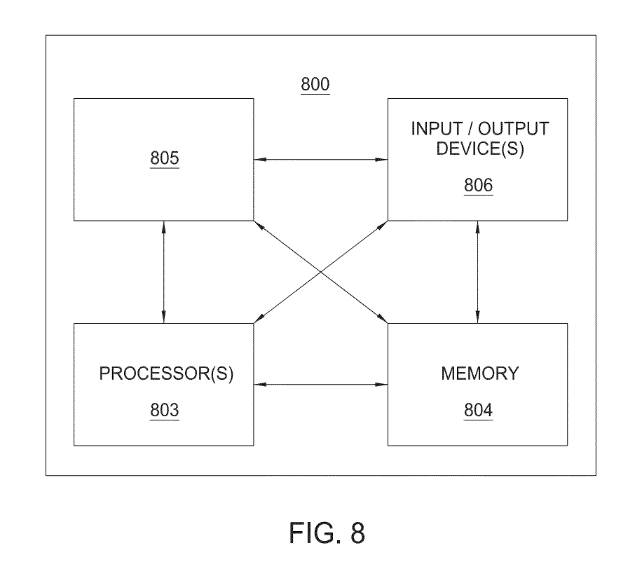

FIG. 8 depicts a high-level block diagram of a computing device, such as a processor in a network element, suitable for use in performing functions described herein such as those associated with the various elements described herein with respect to the figures.

As depicted in FIG. 8, computing device 800 includes a processor element 803 (e.g., a central processing unit (CPU) and/or other suitable processor(s)), a memory 804 (e.g., random access memory (RAM), read only memory (ROM), and the like), a cooperating module/processor 805, and various input/output devices 806 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 805 can be loaded into memory 804 and executed by processor 803 to implement the functions as discussed herein. Thus, cooperating process 805 (including associated data structures) can be stored on a computer readable storage medium, e.g., RAM memory, magnetic or optical drive or diskette, and the like.

It will be appreciated that computing device 800 depicted in FIG. 8 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

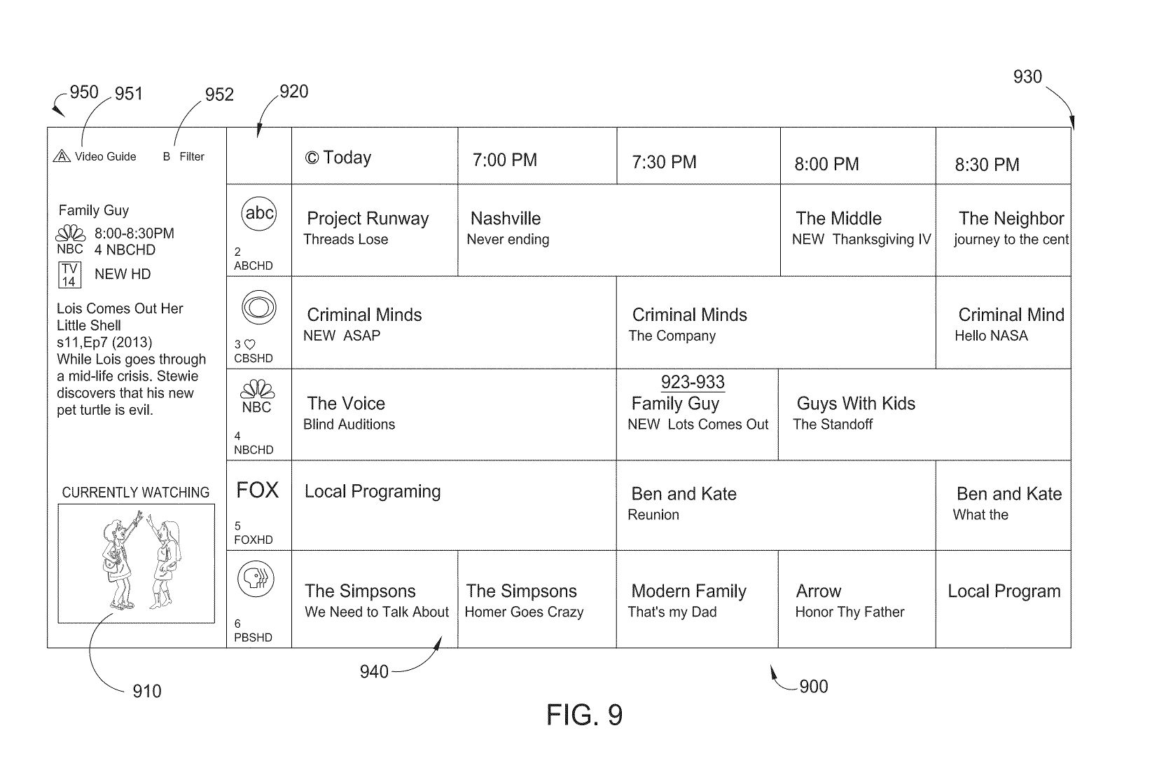

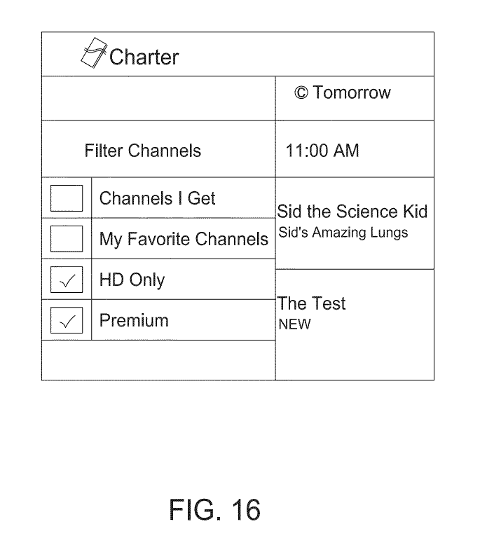

FIGS. 9-18 depict user interface screens in accordance with various embodiments.

FIG. 9 depicts an exemplary UI screen useful in understanding the present invention. Specifically, the UI screen 900 of FIG. 9 is adapted for transmission to a client device as an encoded video stream via a UI channel or path for subsequent video decoding at the client device and presentation via the display device. The UI screen 900 contemplates both still imagery components and moving imagery components. The entirety of the UI display screen is encoded as a video stream for propagation toward the client device.

The UI screen 900 depicts one moving imagery component; namely, an inset video region for presenting moving imagery associated with a currently tuned broadcast channel.

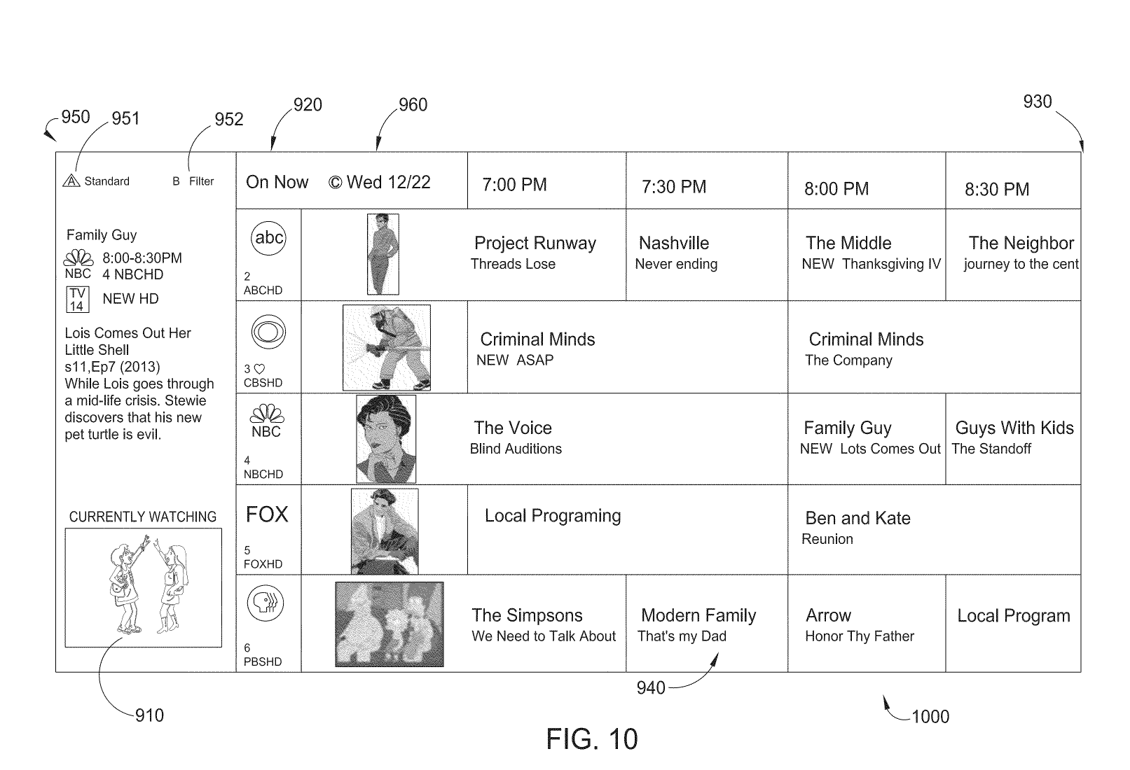

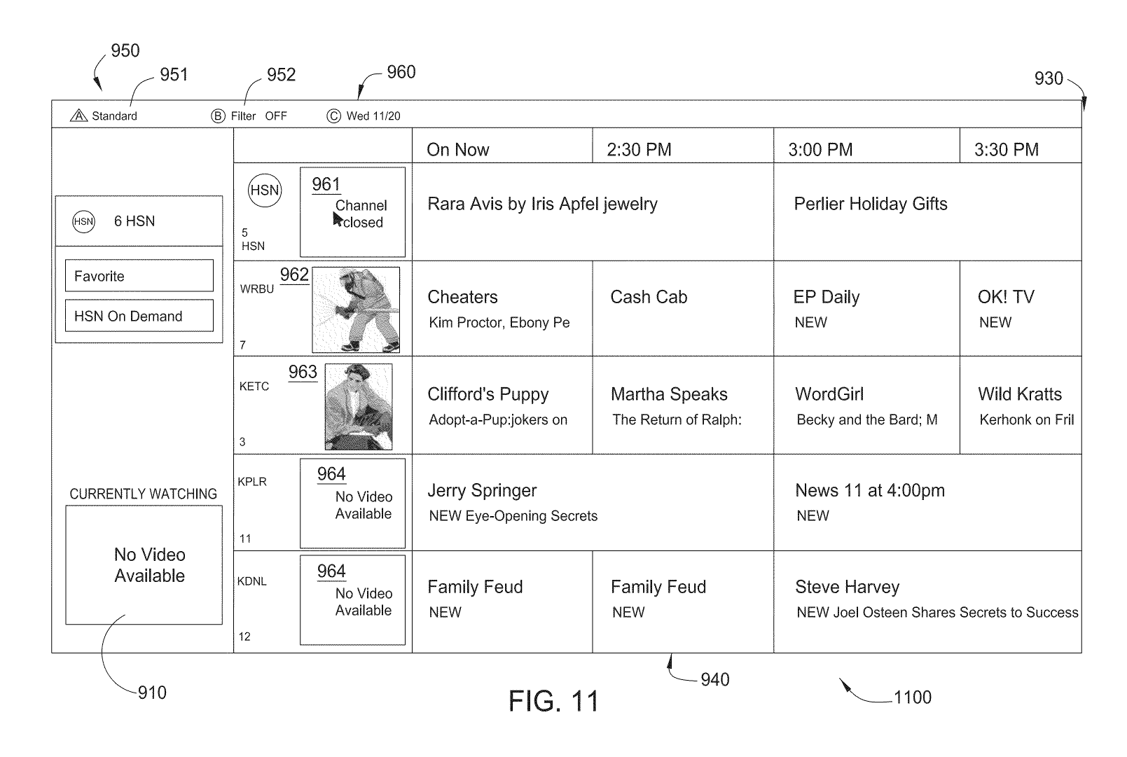

A program guide or grid region 940 includes programming information associated with a plurality of broadcast channels 920 for each of a plurality of timeslots 930. It can be seen that the grid region 940 provides abbreviated programming information associated with each of five broadcast channels during each of five timeslots. Further, it can be seen that a cell correspond to the third broadcast channel 923 and third time slot 933 is highlighted. The abbreviated programming information within this cell is provided in more detail form within a program detail and control region 950. Generally speaking, the program detail and control region 950 displays detailed information about a selected cell within the program guide grid as well as various indicators, selectable controls and the like. For example, a first selectable control 951 is used to toggle between a “Standard” UI presentation (the UI screen 900 of FIG. 9) and a “Video Guide” UI presentation (the UI Screen presentation 1000 of FIG. 10). A second selectable control 952 is used to toggle between a “Filter On” mode (the UI Screens 900 of FIG. 9 and 1000 of FIG. 10) and a “Filter Off” mode (the UI Screen 1100 of FIG. 11).

FIG. 10 depicts an exemplary UI screen useful in understanding the present invention. The UI screen 1000 of FIG. 10 is substantially same as the UI screen 900 of FIG. 9, except that the UI screen 1000 is a “Video Guide” presentation which further includes a vertically disposed video bar 960 including scaled live video imagery associated with each of the five broadcast channels 920 presently selected for display within the programming guide or grid 940.

FIG. 11 depicts an exemplary UI screen useful in understanding the present invention. The UI screen 1100 of FIG. 11 is functionally similar to the UI screen 1000 of FIG. 10, except that the UI screen 1100 operate in a filtered mode wherein video imagery associated with certain channels is blocked. These channels may be blocked due to parental control settings, due to being outside of the purchase channel package of the subscriber or for some other reason. In particular, it can be seen by inspection that a “No Video Available” replacement image is displayed in place of the currently tuned inset image 910, as well as the fourth 964 and fifth 965 cells in the video bar 960. In addition, a “Channel Blocked” replacement image is displayed in place of the first 961 cell in the video bar 960. Different replacement images may be used to denote different reasons for the lack of displayed video.

The various mechanisms described above are well adapted to providing an interactive program guide, user interface (UI) and the like to a television or video service user/subscriber via a set top box (STB) or other consumer premises equipment (CPE). The imagery provided within the context of the interactive program guide, UI and the like may be rendered at the STB/CPE by any of a plurality of known techniques.

Various embodiments contemplate a cloud-based user interface wherein UI imagery is rendered at a remote server or other device such that UI imagery is provided via a compressed video stream, thereby avoiding the need for many STB tuners. For example, various embodiments contemplate a head end server delivering content to a STB via a regional node, wherein the regional node further generates and delivers program guide imagery to the STBs. In various embodiments, the regional node scales live video imagery associated with current channels to provide scaled channel imagery which is then combined with program guide information/functional elements (e.g., HTML, XML or other format) and delivered to the STB.

In operation, data received by the regional node from a particular STB indicative of a desired program guide UI screen is used by the regional mode to generate or stitch together the desired program guide UI screen, which is then delivered to the STB as a stream including UI video imagery including channel thumbnail imagery, as well as program guide information/functional elements. A specific stitching module may be used to generate the desired program guide UI screen at the regional node. The stitching module may include video scaling modules, video/data combination/transport modules and so on.

Various embodiments contemplate the program guide wherein a robust, visually compelling program guide rendered and delivered as a video stream is normally provided to a STB upon session initiation. Various pilots contemplate that a reduced quality or mini-guide be provided to the STB upon session initiation if needed, such as if session initiation requires more than a predetermined amount of time (e.g., two seconds, 10 seconds and the like). The mini guide may be populated with program data stored at the STB, such as a local database comprising a rolling seven days worth of program guide data. This database may be refreshed in the background or as needed.

Further embodiments are directed to specific imagery and/or functionality provided to the user/subscriber via the STB/CPE. In particular, various other embodiments provide specific visual interaction mechanisms wherein the user/subscriber may rapidly select desired content, view content offerings in a visually rich manner, “skim” video imagery associated with present or future content offerings and so on, as will now be described in more detail with respect to the screen images described more detail below.

Various embodiments contemplate a “video bar” at the top, side, bottom or other location of a user interface screen wherein current video imagery associated with various channels is provided as a row of live video thumbnail images which may be selected by a user/subscriber.

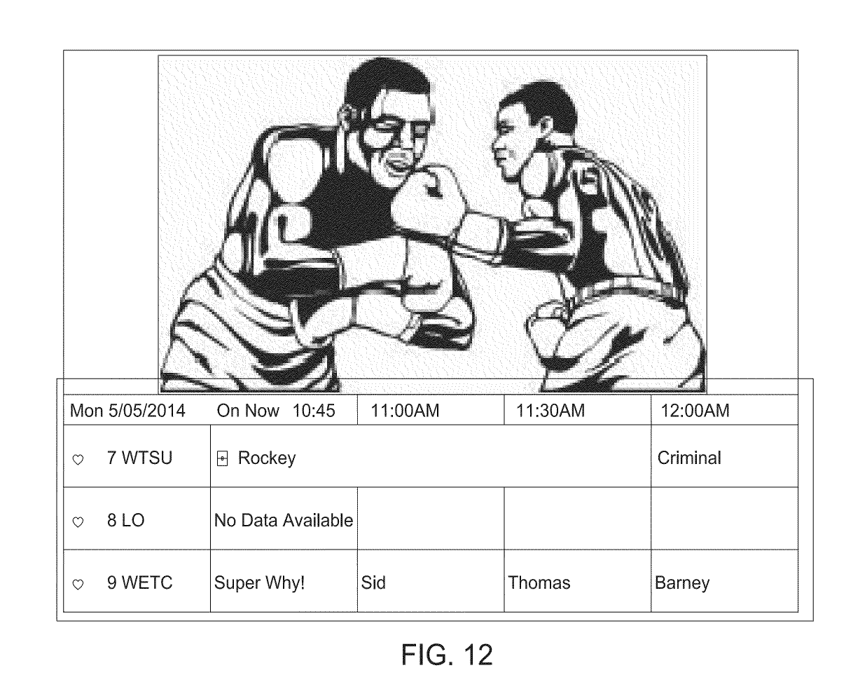

FIGS. 12-18 depict presented program guide imagery in accordance with various embodiments. Specifically, FIGS. 8-14 depict images associated with respective user interface screens displayed to a user/subscriber interacting with a STB/CPE via a presentation device associated with the STB/CPE.

FIG. 12 depicts a user interface screen including a “mini guide” overlaying background imagery associated with a currently presented movie; namely, “Rocky.” It is noted that the mini-guide imagery identifies content offerings by channel/time within the context of a grid depicting channel numbers as a function of time slots including an “On Now” or “current time” time slot as well as a current time display. In various embodiments, the current time display may be toggled on or off via user interaction.

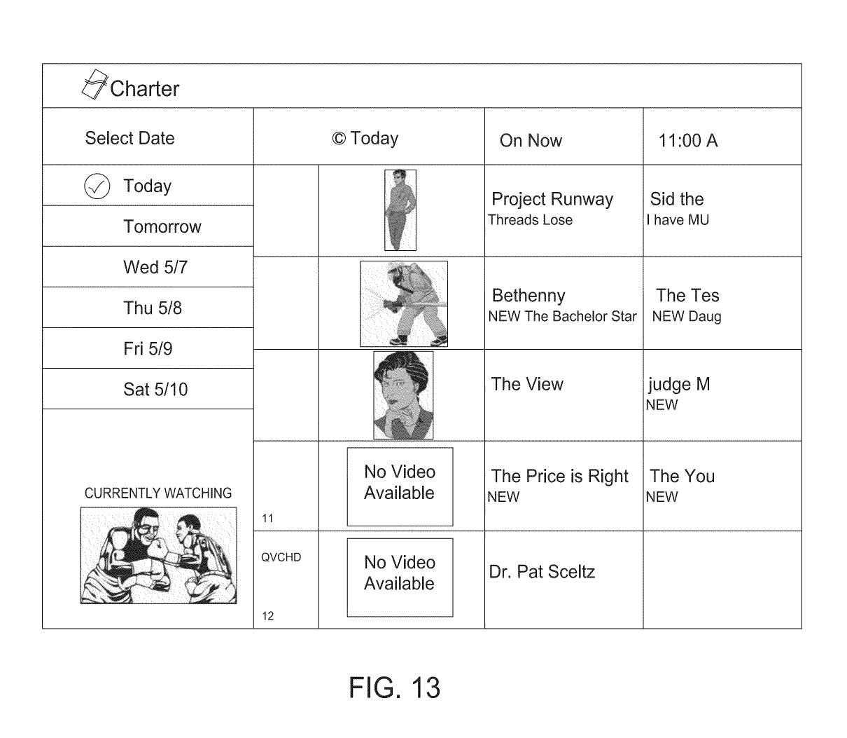

FIGS. 13-18 depict user interface screens associated with various program guide filtering options as well as other options.

Generally speaking, the various interface screens include various screen regions for providing imagery associated with respective user interaction or information functions.

A grid region of various interface screens provides imagery identifying content offerings by channel/time within the context of a grid depicting channel numbers as a function of time slots including an “On Now” or “current time” time slot.

A displayed channel video region, illustratively a column of small video images depicted immediately to the left of the “On Now” or “current time” display column, provides moving video imagery associated with the content offering currently provided by a respective channel (i.e., a subset image displaying the movie or other content that is presently being broadcast or otherwise provided). Generally speaking, thumbnail or subset video imagery of the actual content of TV channels within the program grid itself is displayed in the various embodiments.

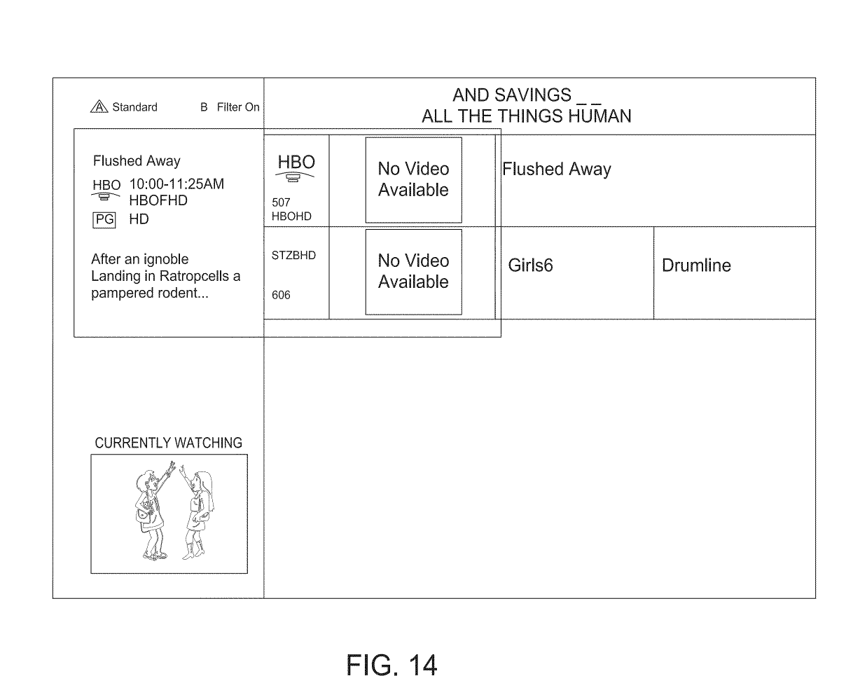

In various embodiments, the thumbnail or subset video imagery of certain channels may not be displayed, such as for adult programming, content outside of a parent controlled setting, content associated with premium channels not available to the user/subscriber (as depicted in FIG. 14) and so on. Where appropriate, the logo or other information pertains to the channel may be displayed.

A currently tuned channel video inset region, illustratively a medium size video image at the lower left of the interface screen, provides moving video imagery associated with the content offering currently provided by the currently tuned channel.

Program Guide Filtering

A program guide filter selection region provides imagery enabling user interaction to select various filtering criteria to thereby filter out or preferentially display within the grid region certain content offerings according to various filtering criteria. Such filtering criteria may comprise a particular date as illustrated in FIG. 13. Other filtering criteria may include channel related criteria such as to prohibit display of specific channels (optionally during specific time slots); content rating criteria such as to prohibit display of content of a certain type or parental control rating; content genre criteria such as to display content associated with preferred genres, actors, directors and so on; time available related criteria such as to display only content viewable within a timeframe presently available to a user and so on. Other filtering criteria may be readily devised by those skilled in the art. In various embodiments, the program guide filter selection region is provided in screen areas other than the upper left corner as depicted herein.

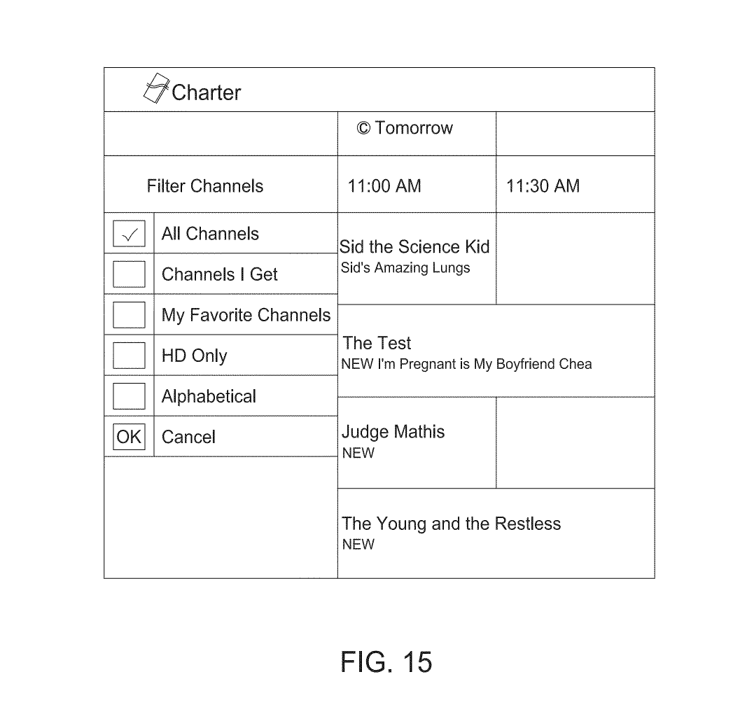

In various embodiments, visual elements associated with filtering criteria are associated with specific shapes and/or colors, such as the round green checkbox imagery depicted in FIG. 13 for selecting “today” as a date filtering criterion (other depicted date filtering criteria including “tomorrow”, Wednesday, Thursday and so on), and the square green checkbox imagery depicted in FIG. 15 for selecting “All Channels” as a channel filtering criterion (other depicted channel filtering criteria including “channels I get”, “my favorite channels”, “high definition (HD) only”, “premium”, “alphabetical” and so on).

Once the user/subscriber interacts with the user interface to select any of the filtering criteria, the program guide imagery in all affected regions will change in response to this selection (e.g., program guide text as well as displayed channel video). Multiple date, time, channel and other criteria may be selected.

In various embodiments, filtering criteria selection is constrained in that only a single selection may be made with respect to a specific filter selection/shape combination, wherein such single selection may be indicated by the presence of a checkmark or other visual indicator (e.g., only one date selection criterion and/or only one channel section criterion). In various embodiments, filtering criterion selections without a checkmark or other visual indicator comprise those criterion selections which may be made in conjunction with other criterion selections, such as the

“Channels I Get” selection which is further constrained by a “HD Only selection and a “Premium Channel” as shown in FIG. 14.

In various embodiments, filtering criteria may be reset each time the STB/CPE power is cycled off and on. In various embodiments, filtering criteria is retained after power off.

User Profiles

In various embodiments, available filtering criteria is associated with particular user profiles, such as by specific family member, specific type of viewer (e.g., adult, teenager, young child) or other profile. Thus, while an adult profile may restrict selection of all of the available filtering criteria, the young child profile may restrict filtering criteria to specific types of content and/or channels.

In various embodiments, the user profiles associated with a particular STB/CPE are remotely stored at a server or other cloud-based entity. Upon power up or initialization of the STB/CPE, a session between the STB/CPE is established and the user profiles associated with the STB/CPE are transmitted from the server to the STB/CPE.

Various embodiments contemplate each STB/CPE being associated with at least one primary or administrator level profile, such as a parent profile within a particular household. Other profiles may be established by the administrator level profile, such as profiles for various children within the particular household.

Various embodiments contemplate user profiles associated with total consumption criteria, time to view criteria and other criteria operative to limit the amount of time or specific time a user such as a child spends watching television. The time to view criteria may be applied to different types of programming, such as educational programming versus non-educational programming wherein educational programming may be given a greater time limit. For example, one hour of non-educational programming time versus a limited or higher limit educational programming time. Various moments contemplate user profiles wherein a non-educational programming time limit is increased in response to certain behaviors, such as watching a predefined amount of educational programming, predefined educational programming content and so on.

The various user profile constraints may be enforced across different user platforms as will be described more detail below.

Sandbox

Various embodiments provide a safe “sandbox” in which only a subset of the available content offerings, and program guide display imagery associated with the content offerings subset, is provided to some or all of the various users. The sandbox may comprise, illustratively, a “kid zone” in which only child safe content and associated program guide displayed imagery is provided. The sandbox may be associated with specific users and/or user profiles. In various embodiments, all users and/or user profiles are placed in an initial sandbox, with users and/or user profile owners able to opt out of the initial sandbox by entering appropriate codes or other mechanisms.

Cross-Platform Coordination

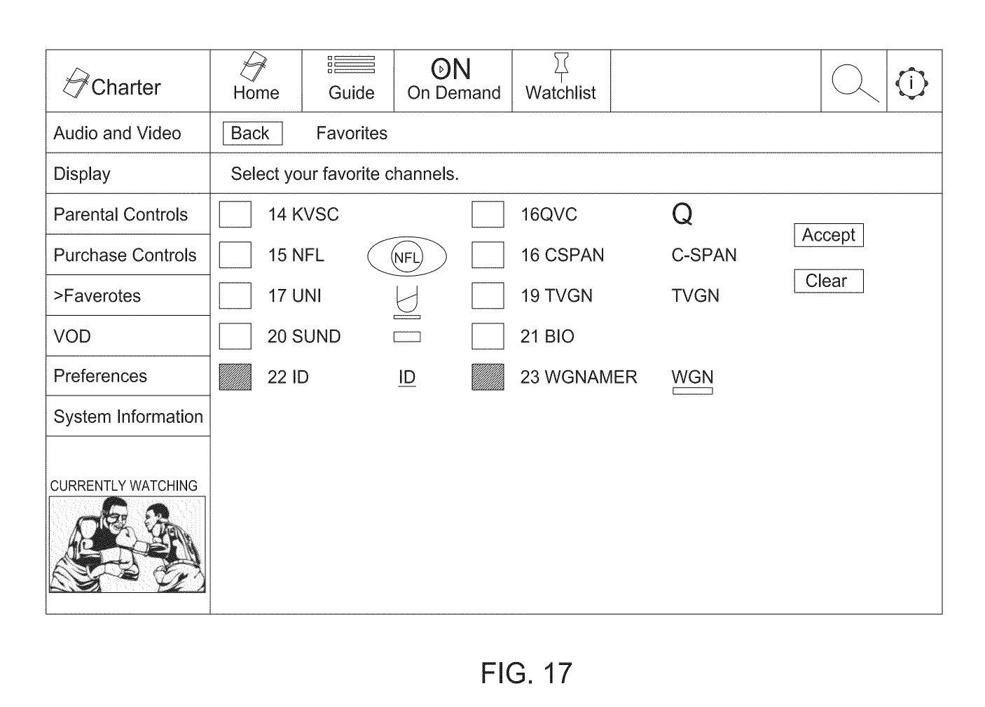

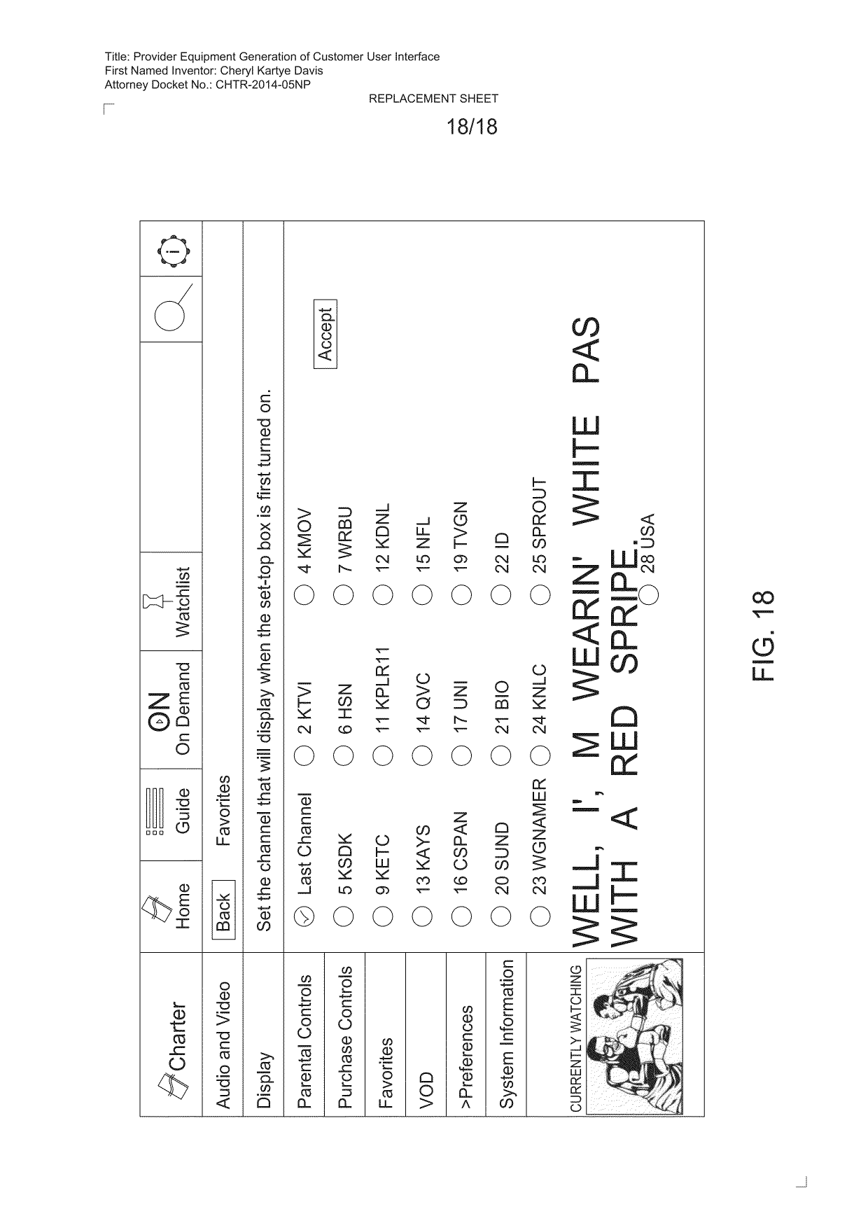

In various embodiments, user profile criteria is invoked on any user platform (e.g., computer, mobile device and so on) to provide thereby a consistent user experience. For example, user/subscriber interaction with a home STB will result in a display, operational or other setting applied across multiple platforms. Examples include, illustratively, selecting one or more favorite channels such as via the user interface screen depicted with respect to FIG. 17, selecting an initial channel to display upon power up such as via the user interface screen depicted with respect to FIG. 18 and so on.

Various embodiments will provide cross-platform operation consistent with the capabilities of the various platforms, such as providing video or program guide imagery of quality level, aspect ratio, frame rate or other parameter appropriate to the particular platform.

Various embodiments enable saving a plurality of prior content searches associated with particular profile such that each of these content searches is available on each of the platforms.

Various embodiments enable reestablishment of sessions at one device that were terminated or interrupted at another device. Such sessions may include live programs, prerecorded programs, programs on demand and the like. In various embodiments, the cloud-based digital video recorder (DVR) stores the entirety of the last broadcast stream presented to a user/subscriber such that the user/subscriber may reestablish an inadvertently terminated session, migrate to a different presentation platform and so on.

The various embodiments contemplate cross-platform operation wherein a primary or administrative user may terminate or otherwise adapt an existing user session, such as a parent terminating the ability of a child to watch television at a present time or some time or range of time in the future.

Exemplary Requirements Document

An exemplary requirements document is depicted below in which various embodiments, as well as requirements associated with specific embodiments are described. Some of these requirements are depicted as present requirements, some of these requirements are depicted as future requirements and so on; however, any of the various embodiments described herein may be modified in accordance with any of the requirements described within the exemplary requirements document. Further, is contemplated that any of the various embodiments described herein whether in the exemplary requirements document or not they be combined in any combination.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A user interface (UI) system, comprising:
a UI generator, at a service provider node in a television distribution system, for encoding UI imagery to provide an encoded video stream bearing said UI imagery and configured for rendering as a UI screen via a client device video decoder, said UI screen including programming information and scaled live video imagery associated with each of a first subset of broadcast channels during a first time interval; and
a scaling module, at the service provider node, for scaling video streams associated with at least the first subset of broadcast channels to provide respective scaled live video imagery for said UI screen.

2. The UI system of claim 1, wherein:
said UI generator, in response to receiving a client request for a UI screen, encoding programming information and scaled live video imagery associated with a requested subset of broadcast channels during a requested time interval.

3. The UI system of claim 2, wherein:
said UI generator, in response to receiving a client request for a UI screen, communicating with a remote network element to retrieve therefrom programming information associated with a requested subset of broadcast channels during a requested time interval.

4. The UI system of claim 1, wherein a default UI screen within said encoded video stream is transmitted toward a client device via a default transmission channel in response to detecting a corresponding client device session initiation.

5. The UI system of claim 4, wherein:
said head end server stores encoded UI assets associated with broadcast channels provided within said television distribution system; and
said UI generator is operable to decode retrieved UI assets for use in forming said UI imagery.

6. The UI system of claim 1, wherein said video stream bearing said UI imagery comprises a plurality of UI screens, each of said UI screens including programming information and scaled live video imagery associated with a respective subset of broadcast channels during said first time interval.

7. The UI system of claim 1, wherein said video stream bearing said U1 imagery comprises a plurality of UI screens, each of said UI screens including programming information and scaled live video imagery associated with said subset of broadcast channels during a respective time interval.

8. The UI system of claim 1, wherein said encoded video stream bearing said UI imagery is transmitted toward said client device via a predefined video transport channel within said service provider network.

9. The UI system of claim 8, wherein a change in video transport channel used to transmit said encoded video stream bearing said UI imagery is advertised to said client device via a control signal.

10. The UI system of claim 1, wherein said remote network element comprises a head end server in a television distribution system.

11. The UI system of claim 1, wherein said service provider node comprises one of a service provider access node associated with one or more client devices, a service provider network node, a service provider server, a UI vendor server and a cable television network head end.

12. The UI system of claim 1, wherein said client device comprises one of a subscriber terminal, a set-top box (STB), a set-top terminal (STT), a smart phone and a computing device.

13. The UI system of claim 1, wherein the scaling module operates to spatially scale broadcast channel video of a first frame size to produce corresponding broadcast channel imagery of a second frame size, where the second frame size is smaller than the first frame size.

14. The UI system of claim 13, wherein the scaling module operates to temporally scale broadcast channel video of a first frame rate to produce corresponding broadcast channel imagery of a second frame rate, where the second frame rate is smaller than the first frame rate.

15. A method of providing a user interface (UI) to a client device in television distribution system, comprising:
at a service provider node in the television distribution system, encoding UI imagery to provide an encoded video stream bearing said UI imagery and configured for rendering as a UI screen via a client device video decoder, said UI screen including programming information associated with each of a subset of broadcast channels during a plurality of time intervals, and scaled live video imagery associated with each of the subset of broadcast channels; and
at the service provider node, scaling video streams associated with at least the subset of broadcast channels to provide respective scaled live video imagery for said UI screen.

16. The method of claim 15, further comprising:
at the service provider node, in response to receiving a client request for a UI screen, encoding programming information and scaled live video imagery associated with a requested subset of broadcast channels during a requested time interval.

17. The method of claim 15, wherein said UI screen includes a programming guide grid depicting broadcast channels as a function of time slots including a current time slot, and wherein each current time slot grid position is adjacent to corresponding broadcast channel scaled live video imagery.

18. The method of claim 15, wherein said UI screen includes a video bar comprising a plurality of adjacent video images, each video image comprising scaled live video imagery of a respective broadcast channel.

19. The method of claim 15, further comprising:
for a UI screen intended to be transmitted to a client device, inhibiting the inclusion therein of scaled live video imagery associated with any broadcast channel prohibited in accordance with a parental control indication associated with the client device.

20. The method of claim 19, further comprising:
for a UI screen intended to be transmitted to a client device, inhibiting the inclusion therein of programming information associated with any broadcast channel prohibited in accordance with the parental control indication associated with the client device.

21. The method of claim 15, further comprising:
for a UI screen intended to be transmitted to a client device, inhibiting the inclusion therein of scaled live video imagery associated with any premium broadcast channel not included within a service agreement associated with the client device.

22. An apparatus, comprising a processor and a storage medium for tangibly storing thereon program logic for execution by the processor, the program logic configured to cause said apparatus to perform a method of providing a user interface (UI) to a client device in television distribution system, the method comprising:
at a service provider node in the television distribution system, encoding UI imagery to provide an encoded video stream bearing said UI imagery and configured for rendering as a UI screen via a client device video decoder, said UI screen including programming information associated with each of a subset of broadcast channels during a plurality of time intervals, and scaled live video imagery associated with each of the subset of broadcast channels; and
at the service provider node, scaling video streams associated with at least the subset of broadcast channels to provide respective scaled live video imagery for said UI screen.

23. A tangible and non-transient computer readable storage medium storing instructions which, when executed by a computer, adapt the operation of the computer to provide a method of providing a user interface (UI) to a client device in television distribution system, the method comprising:
at a service provider node in the television distribution system, encoding UI imagery to provide an encoded video stream bearing said UI imagery and configured for rendering as a UI screen via a client device video decoder, said UI screen including programming information associated with each of a subset of broadcast channels during a plurality of time intervals, and scaled live video imagery associated with each of the subset of broadcast channels; and
at the service provider node, scaling video streams associated with at least the subset of broadcast channels to provide respective scaled live video imagery for said UI screen.

24. A computer program product wherein computer instructions, when executed by a processor in a network management element, adapt the operation of the network management element network element to perform a method of providing a user interface (UI) to a client device in television distribution system, the method comprising:
at a service provider node in the television distribution system, encoding UI imagery to provide an encoded video stream bearing said UI imagery and configured for rendering as a UI screen via a client device video decoder, said UI screen including programming information associated with each of a subset of broadcast channels during a plurality of time intervals, and scaled live video imagery associated with each of the subset of broadcast channels; and
at the service provider node, scaling video streams associated with at least the subset of broadcast channels to provide respective scaled live video imagery for said UI screen.
